(19) United States
(12) Patent Application Publication
(10) Pub. No.: US 2007/0082099 A1
(43) Pub. Date: Apr. 12, 2007

(54) Thermal food transport containers and methods of manufacturing the same

(76) Inventor: Dieter Kellerstrass, Waal (DE)

Correspondence Address: HANLEY, FLIGHT & ZIMMERMAN, LLC, 150 S. WACKER DRIVE, SUITE 2100, CHICAGO, IL, 60606, US

(21) Appl. No.: 11/247,783

(22) Filed: Oct. 11, 2005

(51) Int. Cl. A23L 3/16

(52) U.S. Cl. 426/521

(57) ABSTRACT

Thermal food transport containers and methods of manufacturing the same are disclosed. A disclosed example process for the production of a thermal food transport container or a thermal tray comprises, molding an inside or an outside wall in a first mold from an integral hard foam reaction mixture and at least partially curing the inside or the outside wall. A polyurethane reaction mixture is then molded in a second mold and onto the inside wall or the outside wall and is at least partially cured to form an insulation layer. An integral hard foam reaction mixture is then molded onto the insulation layer of polyurethane foam in a second mold to form the outside wall or the inside wall, so that a bond is formed with the peripheral edge of the first molded wall during curing.

### FIELD OF THE DISCLOSURE

This disclosure relates to processes for the production of thermal food transport containers, thermal trays or the like having a multilayered wall structure, with an inside and an outside wall and, enclosed therebetween, at least one insulation layer made from a polyurethane foam, and to such thermal food transport containers, thermal trays or the like.

### BACKGROUND

Thermal food transport containers, thermal trays or the like, (hereafter abbreviated to “thermal containers”), are used to keep food hot, for example, when these have to be transported from the preparation site to the consumer. Such thermal containers are frequently used for the transport of food, for example, in large catering establishments, canteens and hospitals. There are many different sizes of thermal containers ranging from the container for a single meal to mobile large containers, in which several bowls, pots or trays with a large number of foods can be stored and transported. In the smallest types, the foods are placed directly into the thermal container, which in that case is in the form of a bowl or a deep tray, for example. Thermal containers intended to receive bowls or trays also generally have a cover or a door or hinged lid to close the container. In addition, large thermal containers are generally provided on the inside with ledges or grooves on the side walls, into which trays and the like can be slid in a manner similar to the manner in which a baking tray can be slid into an oven. As a result of the good thermal insulation properties, such thermal containers can also serve to transport products that are to be kept cold, (e.g. in medicine or in the pharmaceutical industry).

The inside and outside walls of the multilayered thermal containers are usually produced by deep-drawing plastic, generally thermoplastics such as polyethylene, or using the rotary process. However, metals, above all stainless steel, can also be used for the inside and outside wall. The inside and outside walls are placed one inside the other after deep-drawing and the peripheral edges of the walls are welded together. In this case, the walls are dimensioned so that a cavity is retained between the inside and outside walls, which, after welding, is filled with polyurethane foam through an opening provided for this purpose. Because of its good thermal insulation properties, the polyurethane foam serves as an actual insulation layer of the container. The described process according to the prior art has a series of disadvantages.

A substantial cost factor in the production of thermal containers using the process according to the prior art is the welding of the peripheral edges of the inside and outside walls. The welding of the two walls must be performed very carefully, since otherwise food residues or cleaning fluid can pass between the two walls during later use. Moreover, a relatively large number of work steps is required in this production process, rendering the production time-consuming and relatively expensive. A further disadvantage is that the thermal containers produced in this manner are made from different materials and are, therefore, difficult to recycle.

### BRIEF DESCRIPTION OF THE DRAWINGS

FIG. 1 is a perspective view of an inside wall of an example thermal container constructed in accordance with the teachings of the invention.

FIG. 2 is a perspective view of the inside wall from FIG. 1 with an insulation layer of polyurethane foam.

FIG. 3 shows an example finished thermal container.

FIG. 4 is a cross-sectional view through an example thermal container constructed in accordance with the teachings of the invention.

### DETAILED DESCRIPTION

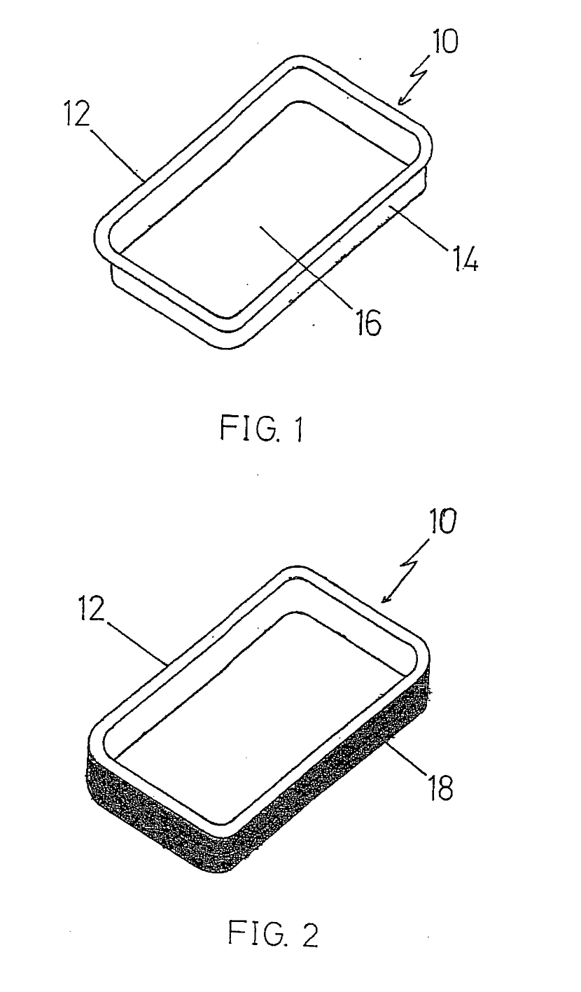

FIG. 1 shows an inside wall 10 made of a polyurethane integral hard foam of an example thermal container constructed in accordance with the teachings of the invention, as molded in the first portion of the process. The example thermal container 10 has side walls 14 and a base 16. The inside wall 10 additionally has a peripheral edge 12, which projects at right angles slightly beyond the side walls 14 in the example shown.

In FIG. 2, the inside wall 10 is enclosed by an insulation layer of polyurethane foam 18 (shown as a dark area). The insulation layer of polyurethane foam 18 completely surrounds the outer surfaces of the side walls 14 and the base 16, so that a good thermal insulation is obtained. In the shown example, the thickness of the insulation layer of the polyurethane foam 18 corresponds to the projection of the edge 12 of the inside wall 10. This is shown particularly clearly in the cross-sectional view in FIG. 4.

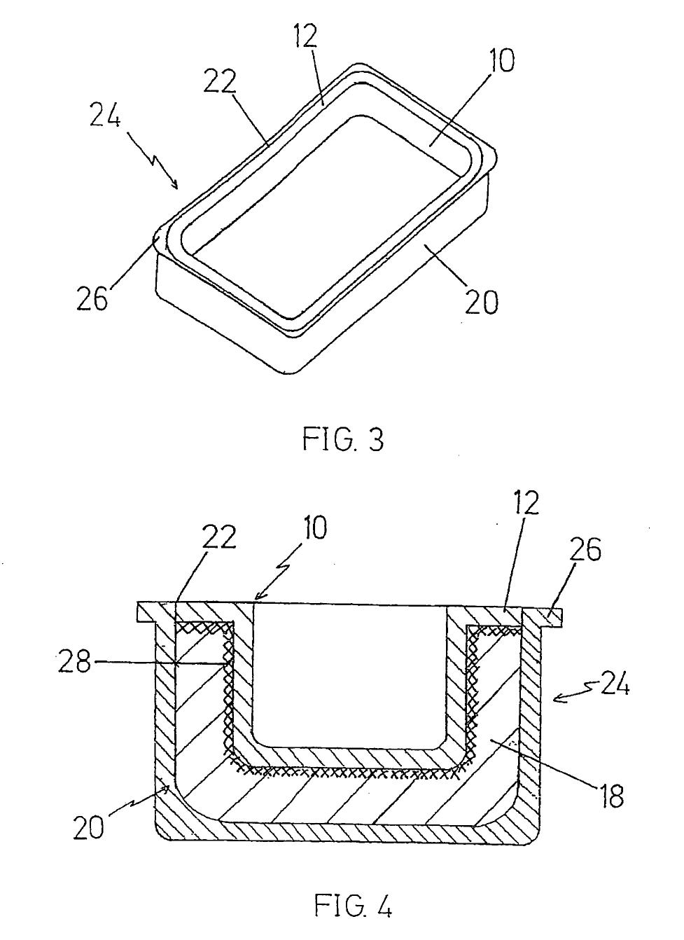

FIG. 3 shows the finished example thermal container 24 after an integral hard foam reaction mixture has been molded onto the insulation layer of polyurethane foam 18 in a last mold to form the outside wall 20. The integral hard foam reaction mixture for the outside wall is preferably composed of polyurethane. The outside wall 20 has a peripheral edge 26. The edge 12 of the inside wall 10 and the edge 26 of the outside wall 20 touch at the seam 22. The two edges 12, 26 are bonded at the seam 22 as the reaction mixture for the outside wall is molded and cured. Therefore, no welding of the inside and outside walls is necessary.

For a better insulation effect, it is possible to insert a layer 28 of highly disperse silicic acid between the insulation layer of polyurethane foam 18 and the inside and/or outside wall 10, 20. Other suitable materials can be used as additional insulation layers instead of the highly disperse silicic acid. The layer 28 of silicic acid is integrated in the thermal container by the foaming of the insulation layer of polyurethane foam 18. FIG. 4 schematically shows how the layer 28 of silicic acid is arranged between the inside wall 10 and the insulation layer of polyurethane foam 18.

The teachings of the invention are, of course, not restricted to the above practical example. On the contrary, the thermal food transport container, thermal tray or the like can have other forms. For example, the container can be deeper or shallower, more elongated and/or square, round, triangular, hexagonal or circular. The wall thicknesses and the thickness of the insulation layer of polyurethane foam can be selected to be thicker or thinner, depending on the specific application and requirement(s). It is, of course, also possible, as has already been described in the introduction to the prior art, to provide the thermal container with a cover or a door or hinged lid or the like to close the thermal container and increase the insulation effect. In this case, the area between the container opening and the door or hinged lid can be provided with one or more seals. In addition, the example thermal food transport containers, thermal trays or the like disclosed herein can also be provided with means for cooling or heating, as is known from the prior art of such products. Moreover, the thermal food transport containers, thermal trays or the like can also be produced with openings for the insertion of heating or cooling elements.

Example processes are disclosed herein, which allow the production of thermal food transport containers, thermal trays or the like to proceed more quickly and/or more inexpensively than according to the prior art.

In an example process disclosed herein for the production of thermal food transport containers, thermal trays or the like with a multilayered wall structure, with an inside and an outside wall and, enclosed therebetween, at least one insulation layer made from a polyurethane foam, the inside or the outside wall is molded in a first mold from an integral hard foam reaction mixture and at least partially cured, in a second mold, a polyurethane reaction mixture is molded onto the inside wall or the outside wall respectively to form the insulation layer and is at least partially cured, and, in a last mold, an integral hard foam reaction mixture is molded onto the insulation layer of polyurethane foam to form the outside wall or inside wall respectively in such a way that this forms a bond with a peripheral edge of the first molded wall during curing.

From the foregoing, persons of ordinary skill in the art will also appreciate that example thermal food transport containers, thermal trays and/or the like produced by the above process have been disclosed.

An example thermal food transport container, thermal tray or the like has a multilayered wall structure, with an inside and an outside wall and, at least one insulation layer made from a polyurethane foam enclosed. therebetween, wherein the inside and the outside wall are composed of an integral hard foam of polyurethane and the two are bonded together along a peripheral edge by reaction during curing.

When molding is mentioned herein, it refers to the so-called foam in situ process, in which a reaction mixture to be foamed is inserted in liquid form into cold molds, which it fills completely after the foaming reaction is finished. This process has some advantages compared to the deep-drawing of thermoplastics or stainless steel, since, for example, the acting forces and the process temperatures are generally lower.

In some disclosed examples, the thermal container to be produced comprises an inside and an outside wall made of an integral hard foam and at least one insulation layer made of a polyurethane foam enclosed between the inside and outside walls. It is also possible to use further insulation layers made of other materials. An example process disclosed herein substantially comprises three stages. In a first process stage, either the inside or the outside wall of the thermal container is produced. This is achieved by molding an integral hard foam reaction mixture in a mold. In this case, the reaction mixture to be foamed is inserted in liquid form into the mold which it completely fills after the foaming reaction has ended. A polyurethane is preferred for use as the material for the integral hard foam, since polyurethane is particularly robust and shock-proof.

After the integral hard foam has cured, the finished inside or outside wall is removed from the mold and inserted into a second mold. The polyurethane insulation layer is produced in a second process stage by filling the second mold with a polyurethane reaction mixture. The second mold is configured so that the foamed polyurethane reaction mixture assumes its final form in the thermal container after curing. The polyurethane foam coats the wall from the first process stage in the manner applicable later in the finished thermal container. If, for example, the inside wall of the thermal container was produced in the first stage, then the polyurethane foam of the insulation layer encloses the outer surfaces of the inside wall, (i.e. the side walls and base thereof). If, however, the outside wall of the thermal container was produced in the first stage, then the polyurethane insulation layer encloses the inner surfaces of the outside wall in the second stage. As already mentioned, the fully cured polyurethane foam of the insulation layer already has substantially its final form at the end of the second stage. If no further insulation layer is provided, the wall with the polyurethane foam from the second process stage is inserted into a third mold in a last stage. Like in the first stage, a reaction mixture to be foamed is inserted into this third mold. The material used in the last stage is again preferably polyurethane. The thermal container is completed in the last mold. If, for example, the inside wall was produced in the first stage, then molding of the outside wall is performed in the last stage. In this case, the outside wall encloses the insulation layer of polyurethane foam of the second stage as far as the peripheral edge of the inside wall. The mold in the last stage is configured so that the freshly molded edge of the last molded wall touches the peripheral edge of the wall molded in the first stage, so that the two edges bond or adhere to one another during curing of the last molded wall. As a result, it is no longer necessary to weld the inside and outside walls of the thermal container to one another. The thermal container is finished after the wall is molded and cured in the last stage of the production process. If polyurethane is used as the material for the inside and outside wall, the entire thermal container is advantageously composed of a single material, which greatly simplifies recycling.

In an advantageous further example, in addition to the insulation layer of polyurethane foam, a layer of highly disperse silicic acid is inserted between one or both walls and the insulation layer of polyurethane foam. The highly disperse silicic acid can be laid on, or wrapped around, the outside of the inside wall in the form of a foil or mat, for example. This foil or mat is then covered by the polyurethane foam. In the last stage, the outside wall is then molded around the insulation layer of polyurethane foam. It is, of course, also possible to apply the highly disperse silicic acid to the insulation layer of polyurethane foam of the second stage, so that the silicic acid layer is located between the polyurethane foam and the outside wall. The process proceeds analogously if the outside wall is produced in the first stage. Other suitable materials can, of course, also be used as additional insulation layers instead of highly disperse silicic acid.

In another advantageous example, threaded inserts for securing closures, handles, wheels or other necessary additional parts are molded into the inside and/or outside wall of structural hard foam. It is also possible to mold recessed grips directly into the walls during production of the inside and/or outside wall.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A process for the production of a thermal food transport container or thermal tray having a multilayered wall structure, the wall structure including an inside and an outside wall and at least one insulation layer made from a polyurethane foam enclosed between the inside wall and the outside wall, the process comprising:
molding the inside or the outside wall in a first mold from an integral hard foam reaction mixture and at least partially curing the inside or the outside wall,
molding a polyurethane reaction mixture in a second mold and onto the inside wall or the outside wall and at least partially curing the polyurethane reaction mixture to form the insulation layer, and
molding an integral hard foam reaction mixture in a third mold and onto the insulation layer of polyurethane foam to form the outside wall or inside wall such that the integral hard foam reaction mixture forms a bond during curing with a peripheral edge of the one of the inside or the outside wall which was formed in the first mold.

2. A process as defined in claim 1, wherein the inside and the outside wall are made from a polyurethane-integral hard foam reaction mixture.

3. A process as defined in claim 1, wherein an insulation layer of highly disperse silicic acid is inserted into the second mold and molded with the polyurethane reaction mixture to form an insulation layer.

4. A process as defined in claim 1, wherein threaded inserts for securing at least one additional part, such as at least one of a closure, a handle, or a wheel, is molded into the inside and/or outside wall, and/or at least one opening is machined therein for the insertion of at least one of a heating element or a cooling element.

5. A thermal food transport container or thermal tray comprising a multilayered wall structure having an inside wall, an outside wall, and at least one insulation layer made from a polyurethane foam enclosed between the inside wall and the outside wall, wherein the inside and the outside wall are composed of an integral hard foam of polyurethane and the inside wall and the outside wall are bonded together along a peripheral edge by reaction during curing.

6. A thermal food transport container or thermal tray as defined in claim 5, wherein a second insulation layer of highly disperse silicic acid is located between one or both of the inside and outside walls and the insulation layer of polyurethane foam.

7. A thermal food transport container or thermal tray as defined in claim 5, wherein at least one threaded insert to secure at least one additional part, such as at least one of a closure, handle, or wheel, is molded into at least one of the inside or the outside wall.

8. A thermal food transport container or thermal tray as defined in claim 5, further comprising at least one opening to receive at least one of a heating element or a cooling element.
